(19) United States
(12) Patent Application Publication
(10) Pub. No.: US 2011/0205124 A1
(43) Pub. Date: Aug. 25, 2011

(54) Object Locator System

(76) Inventor: Ben Shelef, Mountain View, CA (US)

(21) Appl. No.: 13/032,594

(22) Filed: Feb. 22, 2011

Related U.S. Application Data
(60) Provisional application No. 61/306,558, filed on Feb. 22, 2010.

(51) Int. Cl. G01S 5/02

(52) U.S. Cl. 342/450

(57) ABSTRACT

Described is a locating system comprised of a locator and at least one target, the locator having a positioning subsystem such as a GPS receiver capable of determining its own location at any given time, a proximity subsystem such as an RFID reader capable of identifying targets and detecting whether they are within a predetermined threshold range, a memory subsystem capable of storing locations of targets for later recall, and a logic subsystem configured to record into the memory subsystem the last-known location of every target, so that whenever the locator is beyond the threshold range from the target, it can be queried for the last-known position of the target as stored in the memory.

### CROSS-REFERENCE TO RELATED APPLICATIONS

This application claims priority from U.S. Provisional patent application Ser. No. 61/306,558, filed on Feb. 22, 2010, the entirety of which is incorporated herein by reference.

### FIELD

The present application relates to the field of devices for locating lost objects.

### BACKGROUND

People have been losing things ever since they started acquiring them, and so systems for locating lost objects are abundant. Broadly speaking, such systems fall into one of two categories:

“Directional” systems feature a Locator subsystem that is able to detect Target objects that are expected to be lost, and ascertain their position relative to itself. In directional systems, the Targets are active transmitting beacons, and the Locator device includes a directional receiver. These systems are inherently range limited since the Targets are power limited. The directional receiver is complicated, and often requires triangulation to fully locate the Targets.

“Positional” systems feature Target objects that can sense their absolute position and communicate it back to the Locator, usually through a global communication network. Positional systems are not range limited, but require complicated targets that contain, at a minimum, a location sensor (e.g. GPS) and a communication device (e.g. cellular communication node).

The terms “Target” and “Locator” will be used throughout this specification to denote (respectively) the part of the system that is attached to the object expected to be lost, and the part of the system used to locate the Target.

When multiple Targets are used, each Target will have a unique ID associated with it.

### SUMMARY

The invention describe herein is a locating system in which the user uses a Locator device to locate lost Target objects. The advantage of this system is that is uses very simple passive Targets and a Locator that does not need to have either a directional receiver or any communication capability with the Targets. The system is therefore very simple, very inexpensive to build, and is not range limited.

The system is based on having a Proximity subsystem (e.g. RFID) on the Locator capable of detecting whether Targets are within a certain predetermined Threshold range of the Locator and identifying those Targets, a Positioning subsystem (e.g. GPS) capable of finding out the absolute position of the Locator, a Memory subsystem capable of storing location datapoints and associating them with Target IDs, and a Logic and display subsystem.

The novelty of the system is that the Positioning subsystem is located on the Locator and not on the Targets, and the storing of a Positioning datapoint into the Memory system is triggered by a Target leaving the Threshold range of the Proximity subsystem.

Thus the Locator automatically remembers the last-known absolute position of each Target. When queried about the whereabouts of a lost Target, all the Locator has to do is recall its last known position data. To guide the user to it, the Locator only has to compare its own position at the time of the query to the last-known position of the Target.

Clearly the Threshold range must be much smaller than the expected range in which locating will take place. For example, if the RFID threshold range is 1 meter, the Locator will be able to bring the user back to a location which is 1 meter away from the Target, and so is useful for locating Targets that are lost across a range substantially larger than 1 meter.

### DESCRIPTION OF THE DRAWINGS

FIG. 1: Block Diagram

FIG. 2: Flowchart

FIG. 3: Interface Diagram

### DETAILED DESCRIPTION

The invention describe herein is a locating system in which the user uses a Locator device to locate lost Target objects. The advantage of this system is that is uses very simple passive Targets and a Locator that does not need to have either a directional receiver or any communication capability with the Targets. The system is therefore very simple, very inexpensive to build, and is not range limited.

The Locator device has a short-range Proximity subsystem capable of detecting whether Targets are within a certain predetermined Threshold range of the Locator and identifying those Targets.

In this embodiment the Proximity subsystem operates using a transmitter and receiver in the Locator and a transponder in the Target. The transponder responds to a probe signal emitted by the transmitter, and re-emits a return signal that incorporates within it a unique identifier embedded in the Target. If the Proximity subsystem successfully receives the return signal, the Target is deemed within the Threshold range. Otherwise, the Target is deemed outside the Threshold Range. Thus “moving outside of the Threshold range” and “loss-of-signal” are equivalent under this embodiment and the Threshold range might therefore depend on the environmental conditions as they may affect signal strength, but this does not hamper the operating principle of this invention.

One such commercially available system is the RFID system. Another is the Bluetooth system. The RFID system is very suitable since it places an emphasis on very low-cost Targets. Bluetooth is a short range communication system, and so is more complicated and expensive, but it is also already present in a wide variety of devices and so can be taken advantage of without incurring additional costs. Both these systems have globally-unique IDs built into them, though this invention only requires that the Targets used by a certain Locator be unique. Other comparable systems can also be used.

In other embodiments, the range to the target can be calculated using a signal time-delay measurement, in which case moving outside the Threshold range and loss-of-signal are not equivalent.

The Locator device has a global Positioning subsystem capable of finding out the absolute position of the Locator. One of the novel aspects of this invention is that the Positioning system is part of the Locator, not of the Targets.

One such commercially available system is the GPS system, and it is widely incorporated into personal devices such as smart phones. Other similar satellite-based systems are GLONASS and GALILEO, but systems based on ground stations or inertial reference sensors can also be used.

The Locator device has a Memory subsystem capable of storing datapoints produced by the Positioning subsystem and associating them with Target ID values.

Such a system is easily implemented using a general-purpose computer and memory system, and a hash table where the Target ID serves as the key of the Hash and the Positioning datapoint is the value associated with the key. Hash tables are a standard part of computer systems. The Memory system can also be implemented as a simple linear-searchable look-up table.

The Locator device has a Logic subsystem configured to store into the Memory subsystem its own position (as reported by the Positioning device) whenever the Proximity subsystem reports that a certain Target has left the Threshold range. The positioning datapoint is stored as a value associated with Target's ID.

Note that continuously storing a Target's location as long as it is within the threshold range, or storing its location once only when it leaves the threshold range is functionally equivalent. In either case, the location that's left recorded associated with the Target's key is referred to as the Target's last-known location.

The Logic device is easily implemented by programming a general purpose computer or controller, or making use of the facilities present in most any electronic device today such as smart phones, tablet computers, or even wristwatches.

Additionally the Logic subsystem handles interactions with the user when the user wants to query the Locator either for the last-known location of a specific target, or for directions from the Locator's current position to that last-known location of the target.

The novelty of the system is that it does not keep track of where the Targets are at any given time, but of where they were when the Locator was last in their vicinity. Another novelty is that the trigger to determining the last-known is automatic, and the user does not have to remember to perform a specific action to achieve it.

This system does not require any long-range or directional communication capability between the Locator and the Targets, and in particular does not need any such communication to happen when the finding action has to occur. The Targets are simple and inexpensive, and in the preferred embodiment are implemented as standard RFID tags with adhesive backs. Since each tag is unique, the Locator's ability to remember Targets is limited only by its internal memory space.

For example, if a Target is attached to the user's car dashboard, then whenever the user leaves the car (while carrying the Locator) the Locator triggers when the user moves away from the car, so that when subsequently the user emerges from his or her shopping spree and is disoriented, the Locator will indicate how far, and in which direction, the car can be found.

For example, if an RFID tag Target is installed on the user's wallet, and the Locator is built into the user's wristwatch, then if the user drops their wallet in a shopping mall's parking lot some time during the day, and only realizes this when they get home (no matter how far home is from the shopping mall), the Locator will be able to bring the user back to the spot where the Target was last seen by it, without requiring any signal to be exchanged between it and the Target.

In another embodiment, the Locator is programmed onto a smart phone. Since modern smart phones already have GPS and Bluetooth capabilities, and some will soon feature RFID and capabilities and wireless short-distance payment systems, the basic building blocks for a Locator system are already built-in. If the Proximity subsystem is implemented using Bluetooth, the targets must also be Bluetooth devices.

Clearly the threshold range must be much smaller than the expected range in which locating will take place. For example, if the RFID threshold range is 1 meter, the Locator will be able to bring the user back to a location which is 1 meter away from the Target, and so is useful for locating Targets that are lost across a range substantially larger than 1 meter. 1 meter is a natural threshold range since objects are rarely lost within it, and since bringing the user to within 1 meter of an object is considered a successful “find”. However, if under some condition the proximity device kept contact with the object for a larger threshold range (e.g. 5 meter) the basic operation of the Locator is not degraded significantly.

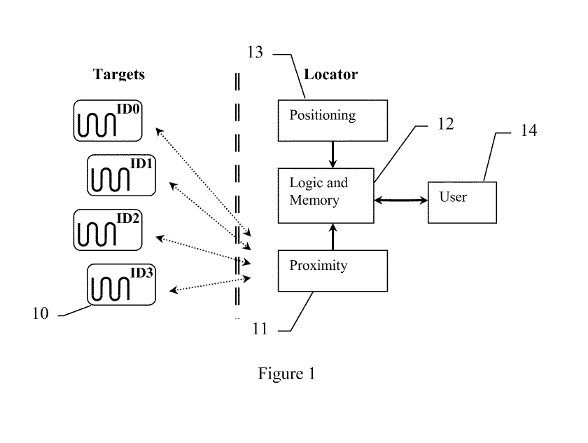

A block diagram of the system is shown in FIG. 1. The Proximity subsystem [11] communicates with the multiple Targets [10] across the Threshold range. The Proximity system also communicates to the Logic subsystem [12] about any Targets having moved out of the Threshold range. The Positioning subsystem [13] also communicates with the Logic subsystem and whenever queried it reports the Locator's location. The Logic subsystem stores this information in the Memory subsystem according to the rules outlined above. The Logic subsystem also interfaces with the user [14].

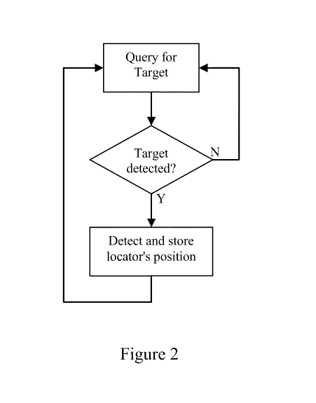

The Logic subsystem operating according to the flowchart shown in FIG. 2. When the Proximity loses contact with any of the Targets (equivalent to the Target having moved out of the Threshold range), it associates its own location at that time with that specific Target, and stores it in a “last-known” memory associated with that Target. At a later time, when queried, the Locator either reports the last-known location of a Target, or indicates based on its own location at the time of the query the distance and direction to the last place the target was sensed. Optionally, the Locator also consults a map database for a graphical representation of the last-known location and for navigational information to it.

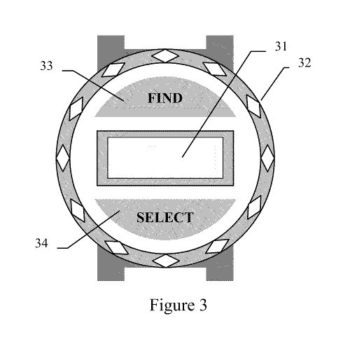

In the embodiment shown in FIG. 3, the Locator is built into a wristwatch like device. When successively clicking on the “Select” button [34], the locator cycles through its remembered Targets (which have previously been assigned symbolic names such as “Car” or “Wallet”) and their locations. Pressing the “Find” button [33] shows the distance to the Target (e.g. “200 yards”) on the display [31] and the direction by lighting one of 12 LEDS [32] that are located on the periphery of the display board. Once queried, the system continuously updates the display as the user moves, intuitively directing them to the location of the Target. To correctly light the directional LEDs, the Positioning device has to have a “compass” feature built into it, which is a standard feature in modern GPS chipsets. The direction LEDs however are not a mandatory part of this invention but rather a user-interface feature.

If the Locator is implemented on a smart phone, it can report back to the user its own location by email or voice, in response to a voice or tone command. This feature (which works as a “Positional” locating system as described above) can help find a lost phone. To prevent this feature being used to track the user, the user carries a special Target on that's always with him (e.g. his wallet or wedding ring) and the Locator is programmed to enable this feature only when this special Target is outside the Threshold range.

What is claimed is:

1. A locating system comprised of a locator device and at least one target, each target having a unique identification key, the locator device having a positioning subsystem capable of determining its own global position, a proximity subsystem capable of detecting whether each target is within a certain predetermined threshold range from the locator and reading the identification key of the targets that are within said threshold range, a memory subsystem capable of storing position data associated with target identification keys, and a logic subsystem connected to said positioning, proximity, and memory systems.

2. The locating system of claim 1, where said logic subsystem is configured to repeatedly store the position of the locator into the memory subsystem, associated with each of the identification keys of target that are within said threshold range as reported by the proximity subsystem.

3. The locating system of claim 1, where said logic subsystem is configured to store the position of the locator into the memory subsystem, associated with the identification key of a target that has transitioned to outside the threshold range, as reported by the proximity subsystem.

4. The system of claim 1, where said positioning subsystem uses a global location system belonging to the group comprising GPS, Galileo, GLANOSS.

5. The system of claim 1, where said proximity subsystem contains a transmitter and a receiver, and said targets contain a transponder configured to respond to a signal from the transmitter by emitting a return signal that the receiver can receive and that includes the identification key of the target, said proximity subsystem configured to indicate that a target is within said threshold range if the receiver successfully receives the return signal from the target in response to a signal from the transmitter.

6. The system of claim 1, where said proximity subsystem contains an RFID reader on the locator and RFID tags on the targets.

7. The system of claim 1, where said proximity subsystem contains of a Bluetooth device on the locator, and a Bluetooth device on each of the targets.

8. The system of claim 1, where said logic subsystem is additionally configured to compare the current location of the locator to any of the locations stored in the memory subsystem, yielding the direction and distance to it.

9. The system of claim 1, where said logic subsystem is additionally configured to compare the current location of the locator to any of the locations stored in the memory subsystem, yielding the direction and distance to it, and query a map database to derive navigation directions to it.

10. The system of claim 1, where the locator features a plurality of indicators arranged around its periphery, indicating the direction of a target.
